(19) United States
(12) Patent Application Publication
(10) Pub. No.: US 2010/0013626 A1
(43) Pub. Date: Jan. 21, 2010

(54) SUBSTRATE LIFT PIN SENSOR

(75) Inventors: Chung-Hee Park, Sungdong-Gu (KR); John M. White, Hayward, CA (US); Dong Kil Yim, Kyunggi-Do (KR)

Correspondence Address: PATTERSON & SHERIDAN, LLP - - APPM/TX, 3040 POST OAK BOULEVARD, SUITE 1500, HOUSTON, TX, 77056, US

(73) Assignee: APPLIED MATERIALS, INC., SANTA CLARA, CA (US)

(21) Appl. No.: 12/501,763

(22) Filed: Jul. 13, 2009

Related U.S. Application Data
(60) Provisional application No. 61/080,923, filed on Jul. 15, 2008.

(51) Int. Cl. G08B 19/00; B05C 11/00

(52) U.S. Cl. 340/521; 118/712

(57) ABSTRACT

Embodiments disclosed herein include a method and apparatus for supporting a substrate. When a substrate is inserted into a processing chamber by an end effector robot, the substrate is placed on one or more lift pins. The lift pins may include a sensing mechanism that can detect whether the substrate is cracked, the lift pin is broken, or the lift pin sticks to the bushing. By detecting the aforementioned conditions, uniform, repeatable deposition may be obtained for multiple substrates.

### CROSS-REFERENCE TO RELATED APPLICATIONS

This application claims benefit of U.S. Provisional Patent Application Ser. No. 61/080,923, filed Jul. 15, 2008, which is herein incorporated by reference.

### BACKGROUND OF THE INVENTION

1. Field of the Invention

Embodiments disclosed herein generally relate to apparatus and methods for supporting a substrate.

2. Description of the Related Art

Liquid crystal displays or flat panels are commonly used for active matrix displays such as computer and television monitors. Generally, flat panels comprise two glass substrates having a layer of liquid crystal material sandwiched therebetween. At least one of the glass substrates includes at least one conductive film disposed thereon that is coupled to a power source. Power, supplied to the conductive film from the power supply, changes the orientation of the liquid crystal material, creating a patterned display. One fabrication process frequently used to produce flat panels is plasma enhanced chemical vapor deposition (PECVD).

PECVD is generally employed to deposit thin films on a substrate, such as a flat panel substrate, a solar panel substrate, an organic light emitting display (OLED) substrate, or a semiconductor wafer. PECVD is generally accomplished by introducing a precursor gas into a vacuum chamber that contains a substrate. The precursor gas is typically directed through a distribution plate situated near the top of the chamber. The precursor gas in the chamber is energized into a plasma discharge by applying RF power to the chamber from one or more RF sources coupled to the chamber. The excited gas reacts to form a layer of material on a surface of the substrate that is positioned on a substrate support.

The substrate may be introduced to the processing chamber on an end effector robot. Transferring the substrate from the end effector robot to the substrate support or susceptor is necessary to permit the substrate to be processed within the processing chamber and removal of the end effector robot. Therefore, there is a need in the art for a processing chamber having lift pins for receiving a substrate from an end effector robot.

### SUMMARY OF THE INVENTION

Embodiments disclosed herein include a method and apparatus for supporting a substrate. When a substrate is inserted into a processing chamber by a robot end effector, the substrate is placed on one or more lift pins. The lift pins may include a sensing mechanism that can detect whether the substrate is cracked, the lift pin is broken, or the lift pin sticks to the substrate or the bushing. By detecting the aforementioned conditions, uniform, repeatable deposition may be obtained for multiple substrates.

One embodiment sets forth an apparatus, which includes a support assembly having a support surface and a bottom surface. The apparatus may also include one or more lift pins movably disposed through the support assembly. The lift pins may have a first end for supporting the workpiece disposed adjacent to the support surface and a second end extending beyond the bottom surface. The apparatus also includes one or more sensor assemblies associated with the one or more lift pins.

Another embodiment sets forth a method, which includes supporting a substrate by a lift pin and measuring a weight applied on the lift pin by the substrate. The measuring may occur through using a weight sensor and/or detecting a proximity of the lift pin through an electromagnetic sensor as the substrate is processed in the processing chamber. The method may also comprise comparing the measured weight and/or the detected proximity to predetermined values and alerting a technician of the difference between the measured weight and the predetermined weight and/or the detected proximity and the predetermined proximity.

In another embodiment, a method for detecting a broken substrate or a broken lift pin in a processing chamber is disclosed. The method includes supporting a substrate by a lift pin and measuring a weight applied on the lift pin by the substrate through a weight sensor and/or detecting a proximity of the lift pin through an electromagnetic sensor. The method also includes comparing the measured weight and/or the detected proximity to predetermined values and signaling a difference between the measured weight and the predetermined weight and/or the detected proximity and the predetermined proximity.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a cross sectional view of a PECVD system during deposition, according to one embodiment of the invention;

FIG. 1B is a cross sectional view of the PECVD system of FIG. 1A before/after deposition;

FIG. 2 is a cross sectional view of a portion of a PECVD system including a weight sensor assembly, according to one embodiment of the invention;

FIG. 3 is a cross sectional view of a portion of a PECVD system including a electromagnetic sensor assembly, according to one embodiment of the invention;

FIG. 4 is a cross sectional view of a portion of a PECVD system including a electromagnetic sensor assembly, according to another embodiment of the invention;

FIG. 5 is a cross sectional view of a portion of a PECVD system including an integrated sensor assembly which includes a weight sensor and an electromagnetic sensor, according to one embodiment of the invention; and

FIG. 6 is a flow chart of detecting abnormal activity in a processing chamber caused by a substrate and/or a lift pin, according to one embodiment of the invention.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments disclosed herein include a method and apparatus for supporting a substrate. When a substrate is inserted into a processing chamber by an end effector robot, the substrate is placed on one or more lift pins. The lift pins may include a sensing mechanism that can detect whether the substrate is cracked, the lift pin is broken, or the lift pin sticks to the substrate or the bushing. By detecting the aforementioned conditions, uniform, repeatable deposition may be obtained for multiple substrates.

The embodiments described herein may be practiced in a PECVD chamber available from AKT America, Inc., a subsidiary of Applied Materials, Inc., Santa Clara, Calif. It is to be understood that the embodiments may be practiced in other processing chambers, including those sold by other manufacturers.

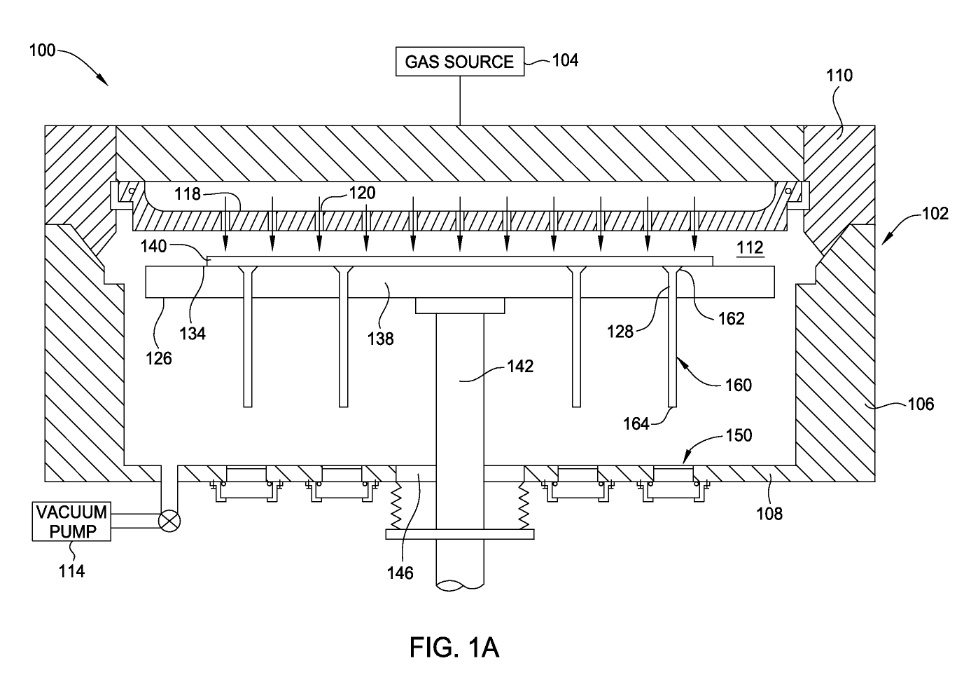

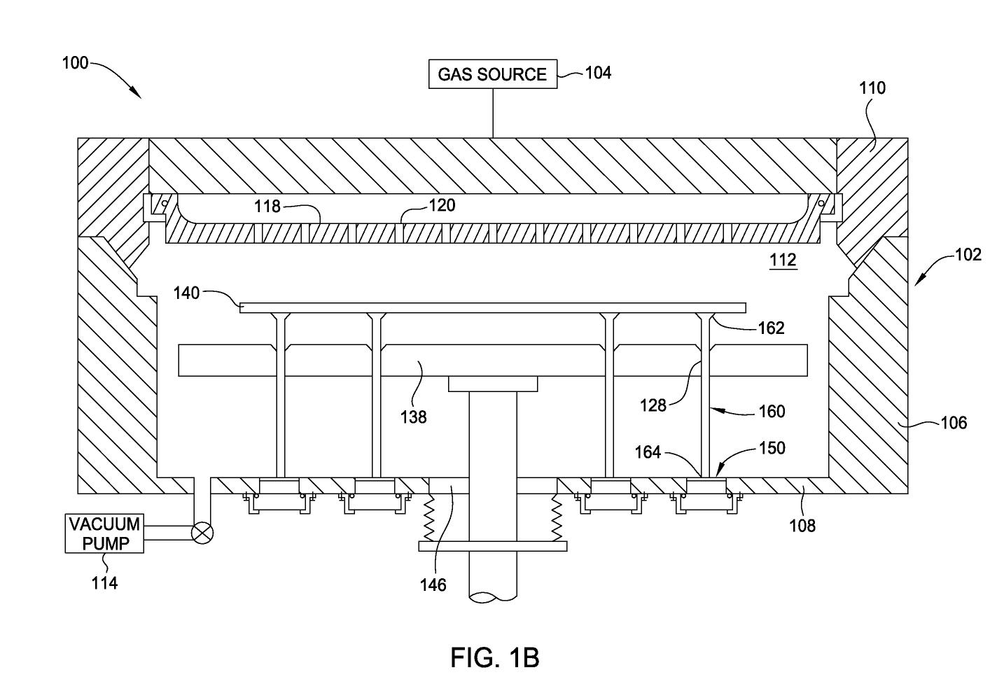

FIG. 1A is a cross sectional view of a PECVD system 100, according to one embodiment of the invention. The PECVD system 100 generally includes a chamber 102 coupled to a gas source 104. The chamber 102 has walls 106, a bottom 108, and a lid assembly 110 that define a process volume 112. The process volume 112 is typically accessed through a port (not shown) in the walls 106, which facilitate movement of the substrate 140 into and out of the chamber 102. The bottom 108 couples to a vacuum pump 114 configured to provide a vacuum environment in the chamber 102. A distribution plate 118 may be coupled to an interior side of the lid assembly 110. The distribution plate 118 has numerous holes 120 passing therethrough. Processing gases from the gas source 104 flow through the holes 120 into the process volume 112.

A substrate support assembly 138 may be centrally disposed within the chamber 102. The substrate support assembly 138 supports a workpiece 140 during processing. The workpiece may be a flat panel display substrate, a solar panel substrate, an OLED substrate, or semiconductor wafer. The substrate support assembly 138 may be coupled to one or more stems 142. The stem 142 couples the substrate support assembly 138 to a lift system (not shown) that moves the substrate support assembly 138 between an elevated position (as shown) and a lowered position. Bellows 146 provides a vacuum seal between the chamber volume 112 and the atmosphere outside the chamber 102 while facilitating the movement of the substrate support assembly 138.

The support assembly 138 has a plurality of holes 128 disposed therethrough to accept a plurality of lift pins 160. In one embodiment, the lift pins may comprise ceramic. Generally, the lift pins 160 have respective heads 162 that are substantially flush with or slightly recessed from a support surface 134 of the substrate support assembly 138 when the lift pins 160 are in a normal position as shown (i.e., retracted relative to the substrate support assembly 138). The heads 162 are generally flared or flanged to prevent the lift pins 160 from falling through the holes 128. Additionally, the lift pins 160 have a respective ends 164 extending beyond an underside 126 of the substrate support assembly 138.

FIG. 1B shows a cross sectional view of a PECVD system 100 when the substrate support assembly 138 is at a lowered position, according to one embodiment of the invention. After processing, the substrate support assembly 138 descends. When the substrate support assembly 138 descends to a certain level, respective ends 164 of lift pins 160 come into contact with sensor assemblies 150. As the substrate support assembly 138 continues to descend from such a level to an even lowered position as shown in FIG. 1B, the heads 162 extend from the substrate support assembly 138 and support the substrate 140.

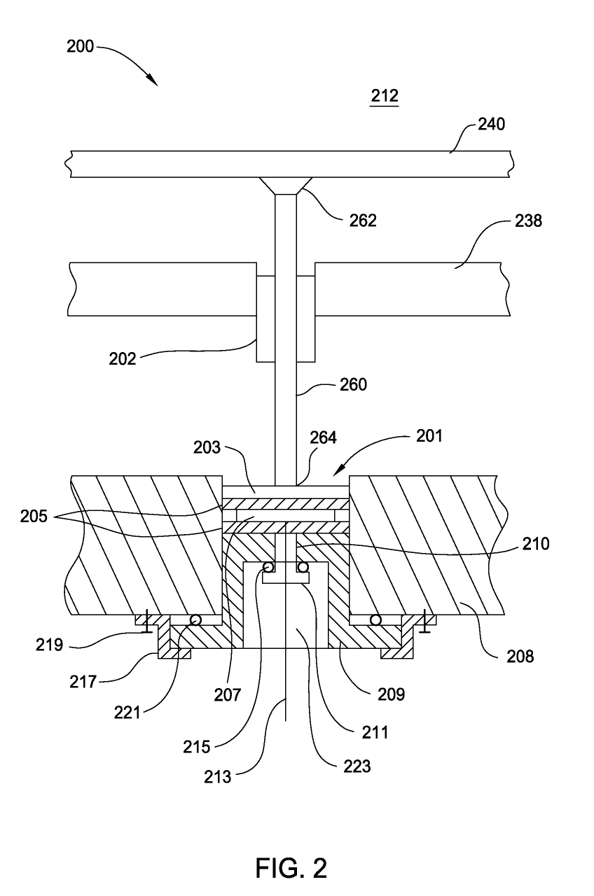

FIG. 2 shows a cross sectional view of a portion of a PECVD system 200, according to one embodiment. A substrate support assembly 238 is at a lowered position right after a substrate 240 is transferred into the chamber of the PECVD system 200 or before the substrate 240 is transferred out of the chamber of the PECVD system 200. Thus a lift pin 260 supports a substrate 240. At this stage, a head 262 of the lift pin 260 contacts the substrate 240 and an end 264 of the lift pin 260 contacts with a sensor assembly 201 embedded in the bottom 208 of the chamber. The lift pin 260 may be made of conventional materials, such as ceramic or aluminum.

The sensor assembly 201 includes a cover 203 configured to contact with the lift pin 260, a thermal insulation material 205 disposed adjacent to the cover 203, a weight sensor 207 disposed adjacent to the thermal insulation material 205, and a cap 209 disposed adjacent to the thermal insulation material 205. The cover 203 may be ceramic. The thermal insulation material 205 may be any material capable of reducing the rate of heat transfer. In one embodiment, the thermal insulation material 205 may comprise Teflon or polytetrafluoroethylene. The weight sensor 207 may be sandwiched between two layers of thermal insulation material 205 or encapsulated in the thermal insulation material 205. The weight sensor 207 may utilize a spring or piezoelectric material to gauge weight.

The cap 209 defines a hole 210 providing a path to a signal line 213 connected to the weight sensor 207. In one embodiment, the cap 209 may comprise aluminum. The signal line 213 is configured to transmit a signal from the weight sensor 207 to a processing unit (not shown) to identify how much weight from the lift pin 260 applies to the weight sensor 207. The cap 209, a fastener 211, and O-rings 215 and 221 provide vacuum seal between the process volume 212 and atmosphere. The fastener 211 may be a screw and the cap 209 is fastened to the bottom 208 by a bolt 219 and a clamp 217.

In one embodiment, the substrate 240 is supported by multiple lift pins. When a portion of the substrate 240 is broken, the lift pin 260 that is configured to support the portion may extend through the broken portion of the substrate 240. Therefore, the weight of the substrate 240 is no longer applied to the lift pin 260, and as a result, the weight sensor 207 fails to properly sense weight. The processing unit receives a signal indicating no weight is detected and then alerts a technician of this abnormal circumstance, possibly the breakage of the substrate 240, around the lift pin 260.

In another embodiment, the lift pin 260 may not extend through the broken portion of the substrate 240, but rather, only a portion of the substrate may rest on the particular lift pin 260. Thus, sensor assembly 201 may sense a disproportionate amount of weight on the particular lift pin 260 instead of a predetermined amount of weight.

In another embodiment, the head 262 of the lift pin 260 may be damaged. Therefore, the weight of the substrate 240 applied to the lift pin 260 with a damaged head 262 may be different than the weight of the substrate 240 applied to an otherwise normal lift pin. The processing unit may also compare weight signals received from different sensors and alert a technician if a weight signal is different from other weight signals. In one embodiment, the processing unit may compare the measured weight signal with a predetermined weight value and inform the user if the measured weight signal is outside of a predetermined acceptable range. In another embodiment, the head 262 of the lift pin 260 may be broken. Therefore, the lift pin 260 may fall through a bushing 202, and no weight can be detected by the weight sensor 207. Alternatively, if the lift pin 260 falls through the bushing 202, the weight sensor 207 may detect the weight of the lift pin 260 while the other lift pins are raised with the susceptor. Thus, the weight sensor measures a weight of the broken lift pin 260 when no weight should be detected.

In another embodiment, the lift pin 260 may stick to the bushing 202 when the substrate support assembly 238 moves upward in the chamber. Thus, the sensor assembly 201 may sense a disproportionate amount of weight on the particular lift pin 260 instead of a predetermined amount of weight.

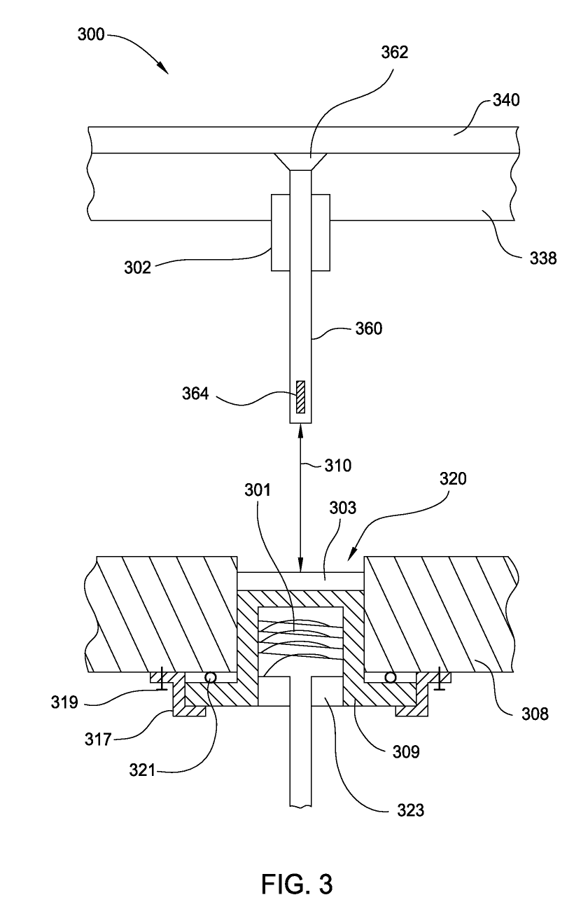

FIG. 3 shows a cross sectional view of a portion of a PECVD system 300, according to one embodiment. The substrate support assembly 338 moves upward and downward to support the substrate 340 during processing. The substrate support assembly 338 actuates a lift pin 360 moving upward and downward. Thus, a distance 310 between the lift pin 360 and a sensor assembly 320 keeps changing while the substrate support assembly 338 is traveling.

The sensor assembly 320 includes an electromagnetic sensor 301, a cover 303, and a cap 309 defining a space 323 enclosing the electromagnetic sensor 301. The lift pin 360 embeds a metal 364. Therefore, the electromagnetic sensor 301 can sense the proximity 310 of the metal 364. In one embodiment, the metal 364 is made of a material having a high magnetic permeability. In one implementation, the material may be steel or nickel. In addition, the cap 309 and the cover 303 are made of a material with a low magnetic permeability. In one implementation, the cap 309 is made of aluminum or austenitic stainless steel, and the cover 303 is made of ceramic. The cap 309, a bolt 319, a clamp 317, and an O-ring 321 provide vacuum seal between the process chamber of the PECVD system 300 and atmosphere. In one embodiment, the electromagnetic sensor 301 may be in atmosphere. In another embodiment, the electromagnetic sensor 301 may be present in the chamber environment.

In one implementation, the electromagnetic sensor 301 may be replaced by an ultrasonic sensor. An ultrasonic sensor generates a high frequency sound wave and evaluates an echo which is received back by the sensor. The ultrasonic sensor then calculates the time interval between sending the wave and receiving the echo to determine the distance to the target. The ultrasonic sensor may detect if the weight of the lift pin 360 is present or if the substrate is broken. The ultrasonic sensor may also detect if the substrate is touching the top of the lift pin 360 or not. The ultrasonic sensor may be disposed outside of the chamber environment such that the ultrasonic sensor is not exposed to any processing or cleaning gases of the chamber environment. The ultrasonic sensor may reduce any sticking of the lift pin 360 to the bushing 302 because some vibration energy would be transferred to the lift pint 360 during operation.

A user may predefine a maximum threshold value and a minimum threshold value of the proximity 310 and set an alarm through a user interface if the proximity 310 is outside the boundary established by the threshold values. The sensor 301 is connected to the user interface through a processing unit interpreting a signal sensed by the sensor 301. For example, when a head 362 of the lift pin 360 is broken, the lift pin 360 may fall through a bushing 302. In this embodiment, the proximity 310 suddenly decreases and may fall below a minimum threshold value set by a user. The sensor 301 senses that the proximity 310 is outside the boundary defined by the preset threshold values and triggers the processing unit to notify the user.

The lift pin 360 may sometimes stick with the bushing 302 when the substrate support assembly 338 moves upward in the chamber to strip the substrate 340 of from the head 362 of the lift pin 360. In this implementation, the proximity 310 may be less than a preset minimum threshold value. Thus, the sensor 301 senses an out-of-range proximity 310, and the user may be notified. It should be noted that an ultrasonic sensor may provide vibration energy to the lift pin 360 to reduce the stickiness between the lift pin 360 and the bushing 302.

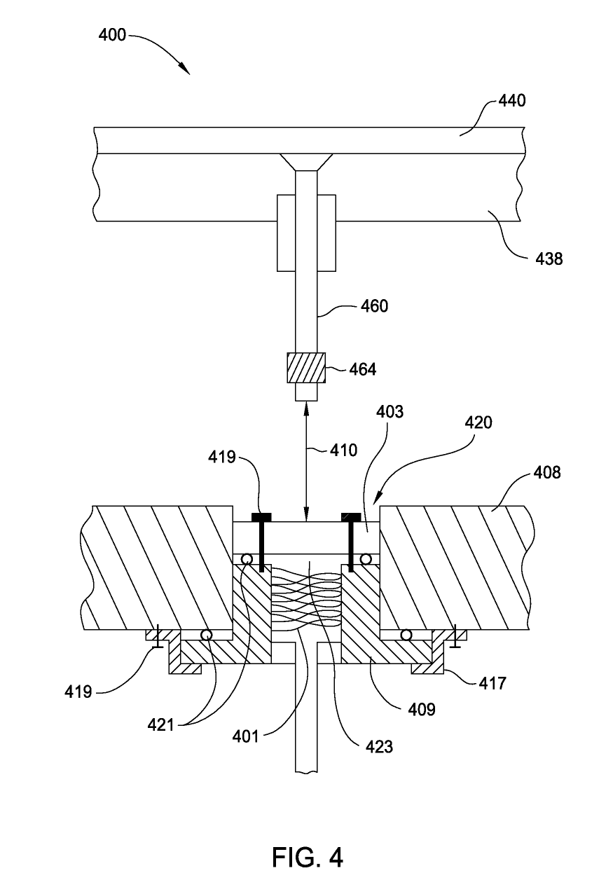

FIG. 4 shows a cross sectional view of a portion of a PECVD system 400, according to one embodiment. As set forth above, a distance 410 between a lift pin 460 and a sensor assembly 420 keeps changing while the substrate support assembly 438 moves upward and downward during processing.

The sensor assembly 420 includes an electromagnetic sensor 401, a cover 403, and a cap 409. In one embodiment, the sensor 401 may be disposed at atmosphere and outside of the processing region. The cap 409, a clamp 417, bolts 419, and O-rings 421 provide a vacuum seal between the process chamber of the PECVD system 400 and atmosphere to reduce exposure of the sensor 401 to the processing environment. In one embodiment, the cap 409 and the cover 403 define a channel 423 in which the sensor 401 may be disposed. The cap 409 may comprise aluminum or austentitic stainless steel. The cover 403 may comprise a material with a low magnetic permeability, such as ceramic.

The lift pin 460 may comprise a high permeability material. In one embodiment, the lift pin 460 may have a high permeability material element 464 coupled to the lift pin 460. In another embodiment, a high permeability material may be embedded in the lift pin 460. In one embodiment, the high permeability material element may comprise nickel. In the embodiment shown in FIG. 4, the sensor 401 is not covered by a metal housing and therefore decreases the interference. In addition, the high permeability material element 464 is not embedded in the lift pin 460 and thus may also decrease the interference for the sensor 401.

As set forth above, a user may predefine a maximum threshold value and a minimum threshold value of the proximity 410 and set an alarm if the proximity 410 is beyond the threshold values through a user interface. A processing unit connected to the sensor 401 is configured to notify the user if the proximity 410 is beyond the threshold values. Thus, the user may intervene.

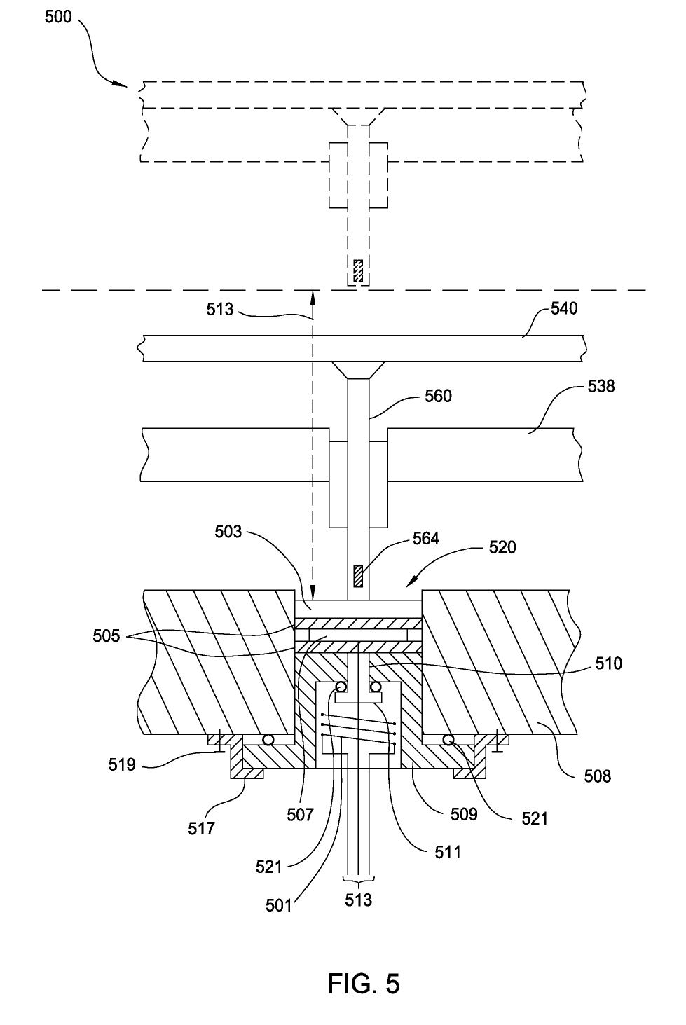

FIG. 5 shows a cross sectional view of a portion of a PECVD system 500, according to one embodiment. In this embodiment, the weight sensor and the electromagnetic sensor set forth above can be integrated into a sensor assembly 520 embedded in the bottom 508 of the processing chamber of the PECVD system 500.

The sensor assembly 520 includes a cover 503 configured to be in contact with a lift pin 560, a thermal insulation material 505 disposed adjacent to the cover 503, a weight sensor 507 disposed adjacent to the thermal insulation material 505, and a cap 509 disposed adjacent to the thermal insulation material 505. The cover 503 may be ceramic. The thermal insulation material 505 may be any material capable of reducing the rate of heat transfer, such as Teflon or polytetrafluoroethylene. The weight sensor 507 may be sandwiched between two layers of thermal insulation material 505 or encapsulated in the thermal insulation material 505.

The cap 509 defines a hole 510 providing a path to a signal line 513 connected to the weight sensor 507. The signal line 513 is configured to transmit a signal from the weight sensor 507 to a processing unit (not shown) to identify how much weight from the lift pin 560 is applied to the weight sensor 507. The cap 509, a fastener 511, and O-rings 521 provide vacuum seal between the processing chamber and atmosphere. The cap 509 is fastened to the bottom 508 by a bolt 519 and a clamp 517. The fastener 511 may be a screw. In one embodiment, the electromagnetic sensor 501 may be in atmosphere. In another embodiment, the electromagnetic sensor 501 may be within the processing chamber environment.

The sensor assembly 520 further includes an electromagnetic sensor 501. The electromagnetic sensor 501 is configured to sense proximity 513 of the lift pin 560 because of the lift pin 560 further embedding a metal 564 with a high magnetic permeability. In one implementation, the metal 564 is steel or nickel.

In another embodiment, the metal 564 is directly disposed on the lift pin 560 to decrease the interference for the electromagnetic sensor 501. Thus the magnetism of the metal 564 is not blocked by the lift pin 560.

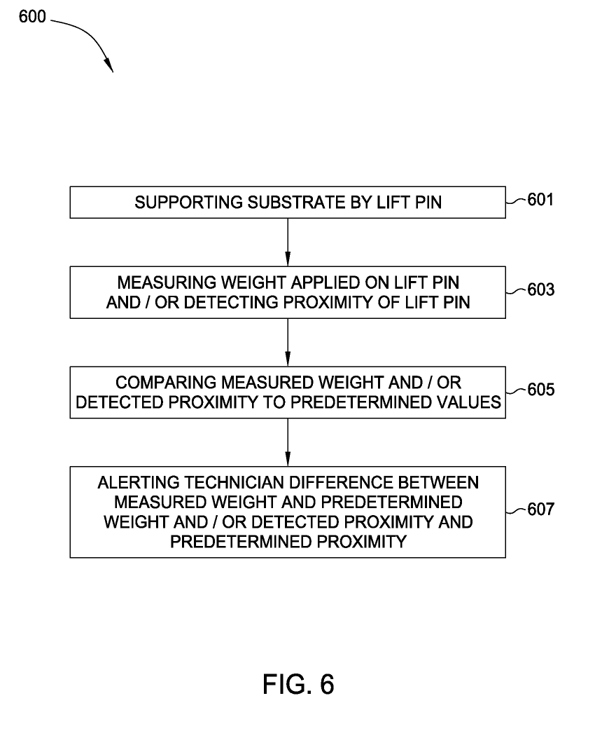

FIG. 6 is a flow chart 600 of detecting an abnormal activity in a processing chamber cause by a substrate and/or a lift pin, according to one embodiment. In step 601, after a substrate is loaded into a processing chamber, the substrate is supported by multiple lift pins. Each lift pin includes a high magnetic permeability material. At this stage, each head of every respective lift pin supports the substrate and each end of the lift pins contacts with respective weight sensors. Therefore, the weight of the substrate is applied to the lift pins and then applied to the weight sensors.

In step 603, the weight substrate applying to the lift pins is measured by the weight sensors. After an end effector robot leaves the processing chamber, a substrate support assembly penetrated by lift pins rises to support the substrate. The substrate support assembly actuates the lift pins by raising the lift pins and each end of the respective lift pins moves away from the weight sensor. Thereafter, an electromagnetic sensor is utilized to detect proximity of a lift pin with a high magnetic permeability material. In one implementation, the high magnetic permeability material is steel or nickel. After the processing is completed, the substrate support assembly descends and actuates the lift pins descending. Each end of lift pins then contacts with the respective weight sensors and each head of the lift pins supports the substrate again. The weight substrate applying to the lift pins is measured again by the weight sensors.

In step 605, the measured weight and detected proximity are compared to a range defined by threshold values preset by a technician. When the substrate or the head of the lift pin is broken or damaged, a particular weight sensor measures no weight or a significantly different value compared to values detected by other weight sensors. When the head of lift pin is damaged or sticks to the bushing, a particular electromagnetic sensor detects an out-of-range proximity. In step 607, when the measured weight and/or the detected proximity is beyond the range defined by threshold values preset by the technician, an alarm is triggered.

It is to be understood that numerous different sensors are contemplated. For example, weight sensors, inductive proximity sensors, capacitive proximity sensors, ultrasonic sensors, and optical-interrupt sensors (i.e., sensors that visually detect) may be used.

By utilizing lift pins with sensing capabilities, broken substrates or broken lift pins may be detected. Detecting broken substrates and/or broken lift pins may permit the broken items to be replaced and prevent system downtime.

While the foregoing is directed to certain embodiments of the present invention, other and further embodiments of the invention may be devised without departing from the basic scope thereof, and the scope thereof is determined by the claims that follow.

What is claimed is:

1. An apparatus for supporting a workpiece in a processing chamber, comprising:
a support assembly disposed within a processing chamber and having a substrate support surface and a bottom surface;
one or more lift pins movably disposed through the support assembly and having a first end for supporting the workpiece disposed adjacent to the substrate support surface and a second end extending beyond the bottom surface, the one or more lift pins movable form a position in contact with a first surface of the processing chamber and a position spaced from the first surface; and
one or more sensor assemblies coupled to the first surface and configured to detect the presence of the one or more lift pins, the absence of the one or more lift pins, correct positioning of the one or more lift pins, incorrect positioning of the one or more lift pins, a broken workpiece and combinations thereof.

2. The apparatus of claim 1, wherein the one or more sensor assemblies is selected from the group consisting of a weight sensor, an ultrasonic sensor, an inductive proximity sensor, a capacitive proximity sensor, and an optical-interrupt sensor.

3. The apparatus of claim 1, wherein each sensor assembly comprises a ceramic or aluminum cover and a sensor, wherein the sensor is environmentally isolated from the one or more lift pins.

4. The apparatus of claim 3, wherein the sensor comprises a weight sensor and is sandwiched between two layers of a thermal insulator.

5. The apparatus of claim 4, wherein the weight sensor is encapsulated in the thermal insulator.

6. The apparatus of claim 1, wherein the one or more lift pins comprises nickel.

7. The apparatus of claim 6, wherein the one or more lift pins comprise nickel embedded within the one or more lift pins.

8. The apparatus of claim 6, wherein the one or more lift pins comprise nickel coupled to an outside surface of the one or more lift pins.

9. The apparatus of claim 1, further comprising a bushing coupled with the substrate support through which the one or more lift pins may move.

10. An apparatus, comprising:
a chamber body that encloses a processing region for processing substrates;
one or more sensor assemblies coupled with the chamber body, the one or more sensor assemblies comprising a sensor environmentally isolated from the processing region;
one or more covers coupled between the one or more sensor assemblies and the chamber body, the one or more covers comprising a material having a first magnetic permeability; and
one or more lift pins disposed within the chamber body and movable from a first position in contact with the one or more covers and a second position spaced from the one or more covers, the one or more lift pins comprising a material having a second magnetic permeability lower than the first magnetic permeability.

11. The apparatus of claim 10, wherein the sensor is selected from the group consisting of a weight sensor, an ultrasonic sensor, an inductive proximity sensor, a capacitive proximity sensor, and an optical-interrupt sensor.

12. The apparatus of claim 10, wherein the material having a first magnetic permeability comprises ceramic.

13. The apparatus of claim 12, wherein the material having a second magnetic permeability comprises nickel.

14. The apparatus of claim 13, wherein the material having a second magnetic permeability is embedded within the one or more lift pins.

15. The apparatus of claim 13, wherein the material having a second magnetic permeability is coupled to an outside surface of the one or more lift pins.

16. The apparatus of claim 10, wherein the material having a second magnetic permeability comprises nickel.

17. The apparatus of claim 10, wherein the material having a second magnetic permeability is embedded within the one or more lift pins.

18. The apparatus of claim 10, wherein the material having a second magnetic permeability is coupled to an outside surface of the one or more lift pins.

19. The apparatus of claim 10, further comprising a bushing coupled with the one or more lift pins.

20. A method for detecting a broken substrate or a broken lift pin in a processing chamber, comprising:
supporting a substrate by a lift pin;
measuring a weight applied on the lift pin by the substrate through a weight sensor and/or detecting a proximity of the lift pin through an electromagnetic sensor;
comparing the measured weight and/or the detected proximity to predetermined values; and
signaling a difference between the measured weight and the predetermined weight and/or the detected proximity and the predetermined proximity.
